(19) United States
(12) Patent Application Publication
(10) Pub. No.: US 2013/0120679 A1
(43) Pub. Date: May 16, 2013

(54) LIQUID CRYSTAL PANEL AND MANUFACTURING METHOD THEREOF, AND LIQUID CRYSTAL DISPLAY DEVICE

(71) Applicant: Guangkui Qin, Beijing (CN)

(72) Inventor: Guangkui Qin, Beijing (CN)

(73) Assignee: BOE TECHNOLOGY GROUP CO., LTD., Beijing (CN)

(21) Appl. No.: 13/701,670

(22) PCT Filed: Jul. 18, 2012
(86) PCT No.: PCT/CN2012/078814

§ 371 Date: Dec. 3, 2012

(30) Foreign Application Priority Data
Jul. 19, 2011 (CN) 201110201850.4

(51) Int. Cl. G02F 1/136

(52) U.S. Cl. 349/42; 438/30

(57) ABSTRACT

A liquid crystal display device comprises a thin film transistor (TFT) substrate, a color filter (CF) substrate, a liquid crystal layer sandwiched between the TFT substrate and the CF substrate, a pixel electrode and a common electrode. Both of the pixel electrode and the common electrode are provided on the TFT substrate and the CF substrate in a same manner, the pixel electrode on the TFT substrate and the pixel electrode on the CF substrate oppose to each other and are applied with a same voltage signal, and the common electrode on the TFT substrate and the common electrode on the CF substrate oppose to each other and are applied with a same voltage signal.

### TECHNICAL FIELD

Embodiments of the present invention relate to a liquid crystal panel and a manufacture method thereof, and a display apparatus.

### BACKGROUND

A liquid crystal panel of an In-Plane Switching (IPS) mode is a high-level liquid crystal panel due to its advantages of wide view angle, high response speed, exact color reproduction and the like. In a liquid crystal panel of an IPS mode, the common electrode and the pixel electrode are formed in a same plane, and a horizontal electric field is formed therebetween upon application of voltages. In contrast, in a conventional liquid crystal operation mode, the common electrode and the pixel electrode are respectively formed on an upper plane and a lower plane, and a vertical electric field is formed therebetween. The IPS technology optimizes the arrangement of the liquid crystal molecules and employs a horizontal arrangement manner. When an external force is applied, the liquid crystal molecules are depressed downward slightly in structure but still maintain the horizontal arrangement as a whole. When the external force is applied, liquid crystal molecules in the IPS mode exhibit excellent robustness and stability in structure, and therefore no image distortion occurs and the image colors will not be adversely affected, and the display effect can be protected from being damaged to a large extent. Therefore, the liquid crystal panels employing the IPS technology are usually referred to as hard-screen liquid crystal panels.

In addition, Advanced-Super Dimensional Switching (AD-SDS) technology is one wide view angle technology for large-size, high-resolution desktop displays and liquid crystal televisions in liquid crystal industry, and also belongs to one kind of hard-screen technologies. In this technology, a multi-dimensional electric field is formed with both a parallel electric field produced at edges of pixel electrodes or common electrodes on the same plane and a vertical electric field produced between a pixel electrode layer and a common electrode layer, so that liquid crystal molecules at all orientations, which are located directly above the pixel and common electrodes and between the pixel electrodes or common electrodes in a liquid crystal cell, can be rotated and aligned, which accordingly enhances the work efficiency of planar-oriented liquid crystals and increases light transmittance. The Advanced-Super Dimensional Switching technology can improve the picture quality of TFT-LCDs and has advantages of high transmissivity, wide viewing angles, high opening ratio, low chromatic aberration, low response time, no push Mura, etc.

The AD-SDS can overcome the problem of the IPS technology of low light transmittance, and can realize high light transmittance with wide view angles. However, in liquid crystal panels employing the IPS technology or the AD-SDS technology, the response speed is still undesirable, and the width of view angles can be improved to a further extent.

### SUMMARY OF THE INVENTION

According to an embodiment of the invention, a liquid crystal panel is provided. The liquid crystal panel comprises a thin film transistor (TFT) substrate, a color filter (CF) substrate, a liquid crystal layer sandwiched between the TFT substrate and the CF substrate, and pixel electrodes and common electrodes for driving liquid crystal. Both of the pixel electrodes and the common electrodes are respectively provided on the TFT substrate and the CF substrate in a same manner, the pixel electrode on the TFT substrate and the pixel electrode on the CF substrate oppose to each other and are applied with a same voltage signal, and the common electrode on the TFT substrate and the common electrode on the CF substrate oppose to each other and are applied with a same voltage signal.

According to another embodiment of the invention, a liquid crystal display device is provided. The liquid crystal display device comprises a polarization sheet and a liquid crystal panel as described above.

According to another embodiment of the invention, a display apparatus is provided. The display apparatus comprises a backlight and a liquid crystal display device. The liquid crystal display device comprises a polarization sheet and a liquid crystal panel as described above.

According to another embodiment of the invention, a manufacture method of a liquid crystal display panel is provided. The liquid crystal panel comprises a thin film transistor (TFT) substrate, a color filter (CF) substrate, a liquid crystal layer sandwiched between the TFT substrate and the CF substrate, pixel electrodes and common electrodes. The method comprises: providing the pixel electrodes and the common electrodes respectively on the TFT substrate and the CF substrate in a same manner, so that the pixel electrode on the TFT substrate and the pixel electrode on the CF substrate oppose to each other, and the common electrode on the TFT substrate and the common electrode on the CF substrate oppose to each other; and applying a same voltage signal to the pixel electrode on the TFT substrate and the pixel electrode on the CF substrate, and applying a same voltage signal to the common electrode on the TFT substrate and the common electrode on the CF substrate.

According to the embodiments of the invention, both of the array substrate and the color filter substrate are provided with pixel electrodes and common electrodes that are disposed opposite to each other, and the same kinds of electrodes on these two substrates are electrically connected with each other. In this way, the response speed can be increased for the liquid crystal panel, the driving voltages applied to the electrodes can be decreased to a great extent, and view angles can be widened, which are helpful for sequential color control, and the technology can be further applied to blue phase liquid crystal display technology.

### BRIEF DESCRIPTION OF THE DRAWINGS

In order to clearly illustrate the technical solution of the embodiments of the invention or that in prior art, the drawings of the embodiments will be briefly described in the following; it is obvious that the described drawings are only related to some embodiments of the invention, and based on the above drawings, those skilled in the art can obtain other drawings without inventive work.

FIG. 1 is a structural schematic view showing a liquid crystal display device of an IPS mode;

FIG. 2 is a structural schematic view showing a liquid crystal display device of an AD-SDS mode;

FIG. 3 is a structural schematic view showing another liquid crystal display device of an AD-SDS mode;

FIG. 4a is a structural schematic view showing a liquid crystal display device of an IPS mode according to an embodiment of the invention;

FIG. 4b is a structural schematic view showing a liquid crystal display device of an AD-SDS mode according to an embodiment of the invention;

FIG. 5 is a schematic view showing the operation principle of the liquid crystal display device of an IPS mode according to an embodiment of the invention;

FIG. 6 is a flow chart showing a manufacture method of a liquid crystal display device according to an embodiment of the invention;

FIG. 7 is a view showing the comparison between the liquid crystal display device of a conventional technology and the liquid crystal display device according to an embodiment of the invention;

FIG. 8 is a view showing the comparison between the transmissivity-voltage relationship of the liquid crystal panel of a conventional technology and that of the liquid crystal panel of an AD-SDS mode according to an embodiment of the invention; and

FIG. 9 is a view showing the comparison between the transmissivity-voltage relationship of the liquid crystal panel of a conventional technology and that of the liquid crystal panel of an IPS mode according to an embodiment of the invention.

### DESCRIPTION OF THE EMBODIMENTS

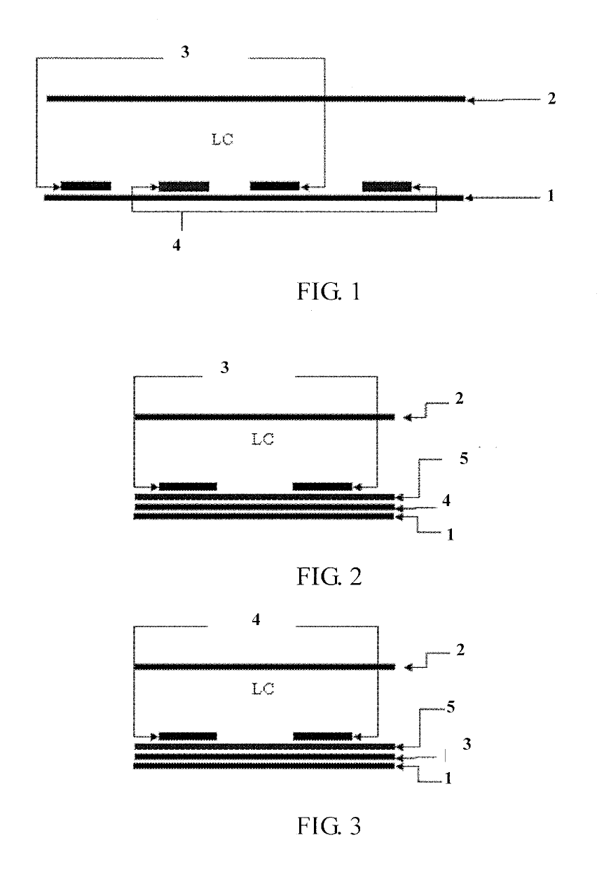

Firstly, the structures of the liquid crystal panels employing an IPS technology (IPS mode) and an AD-SDS technology (AD-SDS mode) will be described for the purpose of better understanding of the invention. FIG. 1 is a structural schematic view showing a liquid crystal panel of an IPS mode. As shown in FIG. 1, the liquid crystal panel of an IPS mode comprises an array (TFT) substrate 1, a color filter (CF) substrate 2 and a liquid crystal (LC) layer sandwiched between the array substrate and the CF substrate. Both of a pixel electrode 3 and a common (Com) electrode 4 are provided on the TFT substrate 1, and they are alternately arranged in a same plane in the state of being insulating from each other.

FIG. 2 is a structural schematic view showing a liquid crystal panel of an AD-SDS mode. As shown in FIG. 2, the liquid crystal panel of an AD-SDS mode comprises an array (TFT) substrate 1, a color filter (CF) substrate 2 and a liquid crystal (LC) layer sandwiched between the array substrate and the CF substrate. A Corn electrode 4 is provided on the TFT substrate, an insulating layer 5 covers the Corn electrode 4, and a pixel electrode 3 is provided on the insulating layer 5. The Corn electrode 4 does not have a slit-shaped opening, while the pixel electrode 3 has a slit-shaped opening.

FIG. 3 is a structural schematic view showing another liquid crystal panel of an AD-SDS mode. As shown in FIG. 3, the liquid crystal panel of an AD-SDS mode comprises an array (TFT) substrate 1, a color filter (CF) substrate 2, and a liquid crystal (LC) layer sandwiched between the array substrate and the CF substrate. A pixel electrode 3 is provided on the array substrate 1, an insulating layer 5 covers the pixel electrode 3, and a Com electrode 4 is provided on the insulating layer 5. The pixel electrode 3 does not have a slit-shaped opening, while the Com electrode 4 has a slit-shaped opening.

Hereinafter, the embodiments of the invention will be described in detail with reference to the accompanying drawings. It is obvious that the described embodiments are just a part but not all of the embodiments of the invention. Based on the described embodiments herein, those skilled in the art can obtain other embodiment(s), without any inventive work, which should be within the scope of the invention.

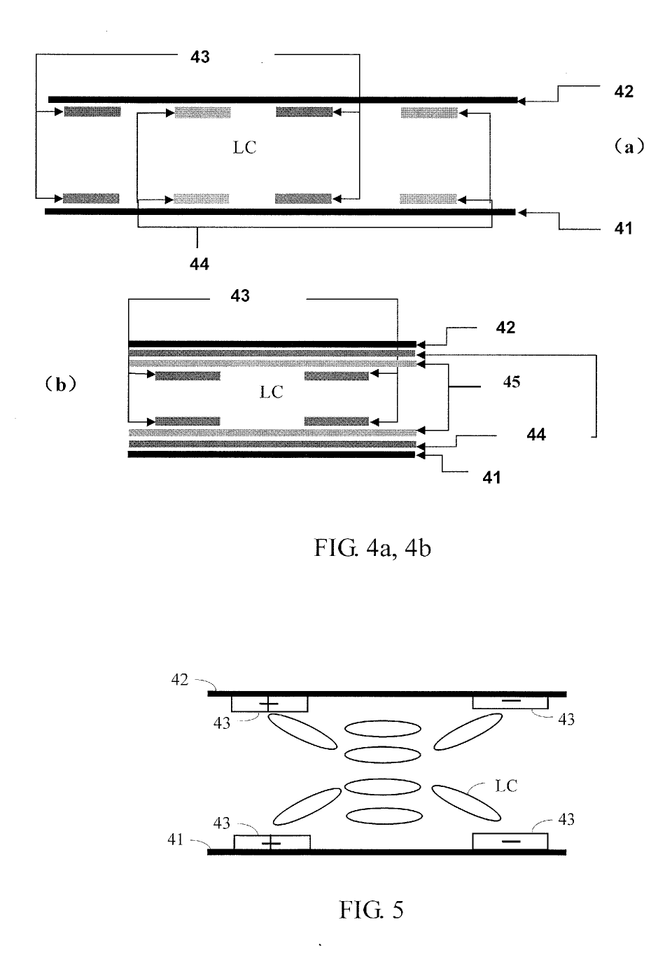

FIG. 4a is a structural schematic view showing a liquid crystal panel of an IPS mode according to an embodiment of the invention, and FIG. 5 is a schematic view showing the operation principle of the liquid crystal panel of an IPS mode according to the embodiment of the invention. As shown in FIG. 4a, the liquid crystal panel comprises a TFT substrate 41, a CF substrate 42, pixel electrodes 43, and common electrodes 44.

On the TFT substrate 41, the pixel electrode 43 and the common electrode 44 are alternately provided in a same plane in a state of being insulating from each other. On the CF substrate 42, the pixel electrode 43 and the common electrode 44 are provided in a same manner as that on the TFT substrate 41. The pixel electrode 43 on the TFT substrate 41 and the pixel electrode 43 on the CF substrate 42 oppose to each other and are applied with a same voltage signal. The common electrode 44 on the TFT substrate 41 and the common electrode 44 on the CF substrate 42 oppose to each other and are applied with a same voltage signal.

The above-described pixel electrodes 43 and common electrodes 44 can be formed on the TFT substrate 41 and the CF substrate 42, respectively, through etching processes.

In an IPS mode, the above-described pixel electrodes 43 and common electrodes 44 may be made of a metal material.

The pixel electrode 43 on the TFT substrate 41 and the pixel electrode 43 on the CF substrate 42 may be electrically connected with each other so that they can be applied with a same voltage signal. Similarly, the common electrode 44 on the TFT substrate 41 and the common electrode 44 on the CF substrate 42 may be electrically connected with each other so that they can be applied with a same voltage signal. In addition, spacers made of a conductive material may be employed to electrically connect the electrodes of same kind respectively provided on the TFT substrate 41 and the CF substrate 42. For example, a spacer made of a conductive material may be provided between the pixel electrode 43 on the TFT substrate 41 and the pixel electrode 41 on the CF substrate 42 so that they are electrically connected with each other. For example, a spacer made of a conductive material may be provided between the common electrode 44 on the TFT substrate 41 and the common electrode 44 on the CF substrate 42 so that they are electrically connected with each other.

FIG. 4b is a structural schematic view showing a liquid crystal panel of an AD-SDS mode according to an embodiment of the invention. As shown in FIG. 5, the device comprises: a TFT substrate 41, a CF substrate 42, pixel electrodes 43, and common electrodes 44.

The Corn electrode 44 is provided on the TFT substrate 41, an insulating layer 45 is provided to cover the Com electrode 44, and the pixel electrode 43 is provided on the insulating layer 4 and has a slit-shaped opening. The pixel electrode 43 has a slit-shaped opening. On the CF substrate 42, the pixel electrode 43 and the common electrode 44 are provided in a same manner as that on the TFT substrate 41. The pixel electrode 43 on the TFT substrate 41 and the pixel electrode 43 on the CF substrate 42 oppose to each other and are applied with a same voltage signal. The common electrode 44 on the TFT substrate 41 and the common electrode 44 on the CF substrate 42 oppose to each other and are applied with a same voltage signal.

It should be noted that, the above-described pixel electrode 43 and common electrode 44 may be interchanged in position. The pixel electrode 43 is provided on the TFT substrate 41, the insulating layer 45 is provided to cover the pixel electrode 43, and the Corn electrode 44 is provided on the insulating layer 45. The Corn electrode 44 has a slit-shaped opening. On the CF substrate 42, the pixel electrode 43 and the common electrode 44 are provided in a same manner as that on the TFT substrate 41. The pixel electrode 43 on the TFT substrate 41 and the pixel electrode 43 on the CF substrate 42 oppose to each other and are applied with a same voltage signal. The common electrode 44 on the TFT substrate 41 and the common electrode 44 on the CF substrate 42 oppose to each other and are applied with a same voltage signal.

The above-described pixel electrode 43 and common electrode 44 can be formed respectively on the TFT substrate 41 and the CF substrate 42 through etching processes.

In an AD-SDS mode, the above-described pixel electrode 43 and common electrode 44 may be made of a transparent electrode such as indium tin oxide (ITO).

The pixel electrode 43 on the TFT substrate 41 and the pixel electrode 43 on the CF substrate 42 may be electrically connected with each other so that they can be applied with a same voltage signal. Similarly, the common electrode 44 on the TFT substrate 41 and the common electrode 44 on the CF substrate 42 may be electrically connected with each other so that they can be applied with a same voltage signal. In addition, spacers made of a conductive material may be employed to electrically connect the electrodes of same kind respectively provided on the TFT substrate 41 and the CF substrate 42. For example, a spacer made of a conductive material may be provided between the pixel electrode 43 on the TFT substrate 41 and the pixel electrode 41 on the CF substrate 42 so that they are electrically connected with each other. For example, a spacer made of a conductive material may be provided between the common electrode 44 on the TFT substrate 41 and the common electrode 44 on the CF substrate 42 so that they are electrically connected with each other.

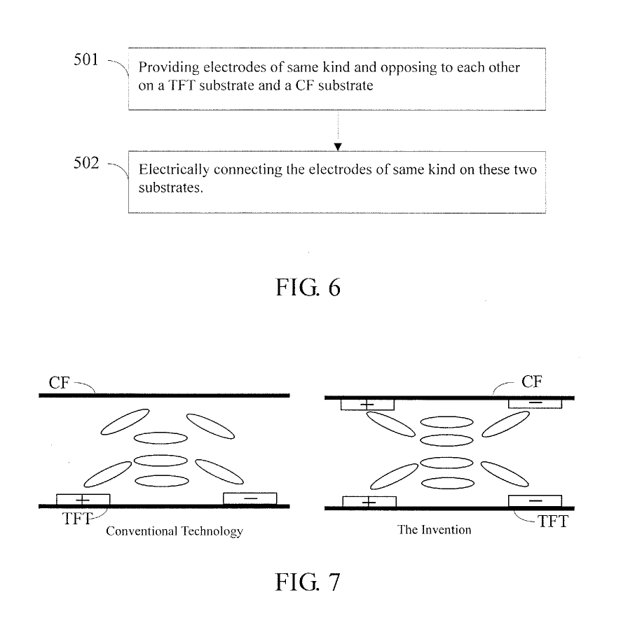

FIG. 6 is a flow chart showing a manufacture method of a liquid crystal panel according to an embodiment of the invention. The method may be applied to the IPS mode liquid crystal panel or the AD-SDS mode liquid crystal panel. As shown in FIG. 6, the method comprises the following steps:

Step 501, providing both pixel electrodes and common electrodes on a TFT substrate and a CF substrate in a same manner so that the pixel electrode on the TFT substrate and the pixel electrode on the CF substrate oppose to each other, and the common electrode on the TFT substrate and the common electrode on the CF substrate oppose to each other.

Patterning processes such as etching processes may be employed to form both the pixel electrode and common electrode on the TFT substrate and the CF substrate, respectively. In an IPS mode, the electrodes may be made of a material such as metal. In an AD-SDS mode, the electrodes may be made of a material such as ITO.

Step 502, applying a same voltage signal on the pixel electrode on the TFT substrate and the pixel electrode on the CF substrate, and applying a same voltage signal on the common electrode on the TFT substrate and on the common electrode on the CF substrate.

The pixel electrode 43 on the TFT substrate 41 and the pixel electrode 43 on the CF substrate 42 may be electrically connected with each other so that they can be applied with a same voltage signal. Similarly, the common electrode 44 on the TFT substrate 41 and the common electrode 44 on the CF substrate 42 may be electrically connected with each other so that they can be applied with a same voltage signal.

The ways to electrically connect the electrodes may include spacers made of a conductive material being provided between the electrodes, which are required to be electrically connected, for electrical connection.

According to another embodiment of the invention, a liquid crystal display device is provided. The liquid crystal display device comprises optical elements including a polarization sheet and a liquid crystal panel as shown in FIG. 4a or 4b.

According to another embodiment of the invention, a display apparatus is provided. The display apparatus comprises a backlight and a liquid crystal display device. The liquid crystal panel comprises polarization sheets and a liquid crystal panel as shown in FIG. 4a or 4b. Here, the display apparatus may be a display apparatus in equipment with a display function such as a mobile phone, a notebook computer, a flat panel computer, a liquid crystal display, a monitor and the like.

FIG. 7 is a view showing the comparison between the liquid crystal display device of a conventional technology and the liquid crystal display device according to an embodiment of the invention. The liquid crystal display device of a conventional technology is shown on the left side of FIG. 7; because, in the conventional technology, two electrodes are used for driving, the electric field on the upper side of the liquid crystal cell is relatively weak, the deflection speed of the liquid crystal molecules is relatively undesirable, the response speed is adversely affected, and at the same time the proportion of the horizontal electric field is low, which is not helpful for liquid crystal deflection in plane. The liquid crystal display device according to an embodiment of the invention is shown on the right side of FIG. 7; both the TFT substrate and the CF substrate are provided with electrodes of same kind that are opposite to each other, and therefore the liquid crystal panel can have an increased response speed, decrease the driving voltage applied on the pixel electrodes to a great extent and widen view angles, which provides desirable conditions for sequential color control, and thus can be applied to a blue phase technology in the future.

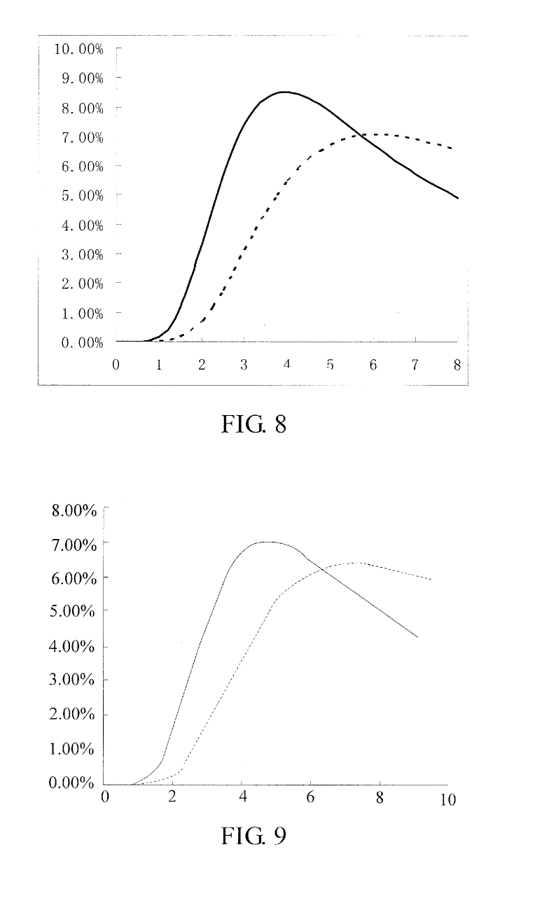

FIG. 8 is a view showing the comparison between the transmissivity-voltage relationship of the liquid crystal panel of a conventional technology and that of the liquid crystal panel of an AD-SDS mode according to an embodiment of the invention. In FIG. 8, the horizontal axis represents the voltage, the vertical axis represents the transmissivity, the solid line corresponds to the case in which the embodiment of the invention is employed, and the dashed line corresponds to the case in which the embodiment of the invention is not employed. FIG. 9 is a view showing the comparison between the transmissivity-voltage relationship of the liquid crystal display device of a conventional technology and that of the liquid crystal panel of an IPS mode according to an embodiment of the invention. In FIG. 8, the horizontal axis represents the voltage, the vertical axis represents the transmissivity, the solid line corresponds to the case in which the embodiment of the invention is employed, and the dashed line corresponds to the case in which the embodiment of the invention is not employed. It can be seen from FIG. 8 and FIG. 9, the liquid crystal display device in the embodiment of the invention can obtain higher transmissivity under relatively lower voltages.

The embodiments described above are only exemplary embodiments but not intended to limit the present invention.

1. A liquid crystal panel, comprising a thin film transistor (TFT) substrate, a color filter (CF) substrate, a liquid crystal layer sandwiched between the TFT substrate and the CF substrate, and pixel electrodes and common electrodes for driving liquid crystal,
wherein both of the pixel electrodes and the common electrodes are respectively provided on the TFT substrate and the CF substrate in a same manner, the pixel electrode on the TFT substrate and the pixel electrode on the CF substrate oppose to each other and are applied with a same voltage signal, and the common electrode on the TFT substrate and the common electrode on the CF substrate oppose to each other and are applied with a same voltage signal.

2. The liquid crystal panel according to claim 1, wherein the pixel electrode and the common electrode on the TFT substrate are alternately arranged in a same plane on the TFT substrate in a state of being insulating from each other, and the pixel electrode and the common electrode on the CF substrate are alternately arranged in a same plane on the CF substrate in a state of being insulating from each other.

3. The liquid crystal panel according to claim 2, wherein the pixel electrodes and the common electrodes are made of a metal material.

4. The liquid crystal panel according to claim 2, wherein the pixel electrode on the TFT substrate and the pixel electrode on the CF substrate are electrically connected with each other so that they are provided with the same voltage signal, or the common electrode on the TFT substrate and the common electrode on the CF substrate are electrically connected with each other so that they are provided with the the same voltage signal.

5. The liquid crystal panel according to claim 4, further comprising a conductive spacer, and the conductive spacer is provided between the pixel electrode on the TFT substrate and the pixel electrode on the CF substrate so that they are electrically connected with each other.

6. The liquid crystal panel according to claim 4, further comprising a conductive spacer, and the another conductive spacer is provided between the common electrode on the TFT substrate and the common electrode on the CF substrate so that they are electrically connected with each other.

7. The liquid crystal panel according to claim 1, further comprising:
a first insulating layer covering the common electrode on the TFT substrate, the pixel electrode on the TFT substrate being provided on the first insulating layer and having a slit-shaped opening; and
a second insulating layer covering the common electrode on the CF substrate, the pixel electrode on the CF substrate being provided on the second insulating layer and having a slit-shaped opening.

8. The liquid crystal panel according to claim 7, wherein the pixel electrodes and the common electrode are made of a transparent conductive material.

9. The liquid crystal panel according to claim 7, wherein the pixel electrode on the TFT substrate and the pixel electrode on the CF substrate are electrically connected with each other so that they are provided with the same voltage signal, or the common electrode on the TFT substrate and the common electrode on the CF substrate are electrically connected with each other so that they are provided with the the same voltage signal.

10. The liquid crystal panel according to claim 9, further comprising a conductive spacer, and the conductive spacer is provided between the pixel electrode on the TFT substrate and the pixel electrode on the CF substrate so that they are electrically connected with each other.

11. The liquid crystal panel according to claim 9, further comprising a conductive spacer, and the another conductive spacer is provided between the common electrode on the TFT substrate and the common electrode on the CF substrate so that they are electrically connected with each other.

12. The liquid crystal panel according to claim 1. further comprising:
a first insulating layer covering the pixel electrode on the TFT substrate, the common electrode on the TFT substrate being provided on the first insulating layer and having a slit-shaped opening; and
a second insulating layer covering the pixel electrode on the CF substrate, the common electrode on the CF substrate being provided on the second insulating layer and having a slit-shaped opening.

13. The liquid crystal panel according to claim 12, wherein the pixel electrodes and the common electrode are made of a transparent conductive material.

14. The liquid crystal panel according to claim 12, wherein the pixel electrode on the TFT substrate and the pixel electrode on the CF substrate are electrically connected with each other so that they are provided with the same voltage signal, or the common electrode on the TFT substrate and the common electrode on the CF substrate are electrically connected with each other so that they are provided with the the same voltage signal.

15. The liquid crystal panel according to claim 14, further comprising a conductive spacer, and the conductive spacer is provided between the pixel electrode on the TFT substrate and the pixel electrode on the CF substrate so that they are electrically connected with each other.

16. The liquid crystal panel according to claim 9, further comprising a conductive spacer, and the another conductive spacer is provided between the common electrode on the TFT substrate and the common electrode on the CF substrate so that they are electrically connected with each other.

17. A liquid crystal display device, comprising a polarization sheet and a liquid crystal panel according to claim 1.

18. A method for manufacturing a liquid crystal panel, the liquid crystal panel comprising a thin film transistor (TFT) substrate, a color filter (CF) substrate, a liquid crystal layer sandwiched between the TFT substrate and the CF substrate, pixel electrodes and common electrodes, the method comprising:
providing the pixel electrodes and the common electrodes respectively on the TFT substrate and the CF substrate in a same manner, so that the pixel electrode on the TFT substrate and the pixel electrode on the CF substrate oppose to each other, and the common electrode on the TFT substrate and the common electrode on the CF substrate oppose to each other; and
applying a same voltage signal to the pixel electrode on the TFT substrate and the pixel electrode on the CF substrate, and applying a same voltage signal to the common electrode on the TFT substrate and the common electrode on the CF substrate.

19. The method according to claim 18, wherein the pixel electrodes and the common electrodes are formed on the TFT substrate and the CF substrate by patterning processes.

20. The method according to claim 18, wherein the electrodes are made of a material of metal or ITO.
